(19) United States
(12) Patent Application Publication
(10) Pub. No.: US 2007/0002441 A1
(43) Pub. Date: Jan. 4, 2007

(54) Three-dimensional display device for terminal

(76) Inventors: Eun-Soo Kim, Seoul (KR); Sun-Joo Jang, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/514,615

(22) Filed: Aug. 31, 2006

Related U.S. Application Data
(63) Continuation of application No. PCT/KR05/00718, filed on Mar. 11, 2005.

(30) Foreign Application Priority Data
Dec. 31, 2004 (KR) 10-2004-0118291

(51) Int. Cl. G02B 27/22

(52) U.S. Cl. 359/462; 353/2

(57) ABSTRACT

A three-dimensional image display device is disclosed. In one embodiment, the device creates an effect of a three-dimensional image floating in the air by projecting a two-dimensional image to a free space in a form of a three-dimensional image. According to one embodiment of the invention, the device can be implemented with a minimal space in the structure of a conventional vending machine, comprising a minimal number of components and low-cost parts. It is possible to produce a large quantity of three-dimensional image display devices at a low cost.

### RELATED APPLICATIONS

This application is a continuation application, and claims the benefit under 35 U.S.C. §§ 120 and 365 of PCT Application No. PCT/KR2005/000718, filed on Feb. 22, 2006, which is hereby incorporated by reference.

### BACKGROUND OF THE INVENTION

1. Field of the Invention

The present invention relates to a three-dimensional image display device applied to an unattended information terminal such as a typical vending machine, more specifically to a three-dimensional image display device creating an effect of a three-dimensional image floating in the air by projecting a two-dimensional image of the source to a free space in the form of a three-dimensional image.

2. Description of the Related Technology

With the increasing interest in three-dimensional images, many related technologies have been introduced. Some of these conventional technologies attempt to apply three-dimensional images commercially, such as for advertisements. In particular, a lenticular method is widely used in, for example, advertisements for an unspecified number of persons. The lenticular method gives a three-dimensional effect by allowing the left eye and right eye to see slightly different perspectives, using different view points of the left eye and right eye. However, when this technology is applied in a lenticular screen, which eliminated the discomfort of having to wear special eye-glasses, it is found to be effective only in some of the still images. Despite various improvements such as the parallax barrier, viewers find it difficult to watch the images for a long time due to headaches and dizziness.

Other methods have also been introduced using concave mirrors or lenses, but these methods have problems of requiring a large space in the device to secure a sufficient distance for optical projection in order to create a three-dimensional image based on optical principles, high costs of materials such as concave mirrors or translucent mirrors, and distortion of the image.

Referring to FIG. 1, a conventional three-dimensional image display device consists of an object image source 34 and a reflector 35 for reflecting the object image source, a background image source 33 and a transparent mirror 36 for projecting this background image source, a Fresnel lens 37 for enlarging the image source and an additional Fresnel lens 38, and a first Fresnel lens 39 and a second Fresnel lens 40 for three-dimensional display.

Although the above conventional technology realizes two or more image sources in the form of a three-dimensional image 41 and projects the object image source 34 with perspective, a number of Fresnel lenses are needed to enlarge the object image source 34, and it requires that the device be large due to the distance needed between the elements. Hence, it is difficult to apply a structure shown in FIG. 1 in a conventional sales device such as a vending machine, which subsequently becomes larger if applied with the structure.

The holographic technology and volumetric 3D technology, which are capable of providing fully 3-dimensional images, have been experiencing difficulties in realizing full-color, real-time video and in controlling, arranging, and manufacturing precision optical components. Moreover, it has been unrealistic to display large 3-dimensional images using these technologies due to high costs of the components.

### SUMMARY OF CERTAIN INVENTIVE ASPECTS

One aspect of the invention provides a three-dimensional image that can be implemented with a minimal space in the structure of an unattended information terminal, such as a vending machine, comprising a minimal number of components and low-cost parts.

Another aspect of the invention provides a three-dimensional image display device comprising i) an image source supply unit for supplying an image source, ii) an image source supply unit for supplying an image source, iii) a reflector, supported by a strut to form an acute angle with the image source supply unit, for reflecting the image source projected by the image source supply unit, iv) a Fresnel lens unit, forming an acute angle with the reflector and supported by a strut to form a right angle with the image source supply unit, for forming a three-dimensional image on a focal plane by refracting and enlarging an image reflected by the reflector and v) a control unit for organically controlling the image source supply unit, reflector, and Fresnel lens unit.

In one embodiment, the Fresnel lens unit has a focal length and comprises a first Fresnel lens, to which the refracted image is projected, a second Fresnel lens, from which the three-dimensional image is projected, and a film mask, for removal of circular patterns, in the projecting direction of the second Fresnel lens. In one embodiment, the control unit extracts image information corresponding to the selection of a button, equipped on the terminal, and provides the image information to the image source supply unit.

Another aspect of the present invention provides three-dimensional images, which allow viewer to experience deeper perspectives, by realizing these two-dimensional images to real-time three-dimensional images.

In one embodiment, a three-dimensional image display device for a vending machine has an image source and two Fresnel lenses. The two Fresnel lenses may have one focal length, and form a focal plane for the image source according to the focal length. The lens may be a positive relief Fresnel lens, which converges the incident light to a focal point or refracts the spreading light to become parallel. In one embodiment, the positive relief Fresnel lenses, which are available from 3Dlens Corporation or Edmund Optics, Inc. of Taiwan, are widely used in overhead projectors and TVs.

In one embodiment of the present invention, a reflector is used to minimize the optical distance between the image source and the two Fresnel lenses. Hence, the image from the image source is refracted by 90° on the reflector, which is tilted by 45° and projected toward the two Fresnel lenses, thereby creating an effect of floating in the air as a three-dimensional image.

### BRIEF DESCRIPTION OF THE DRAWINGS

FIG. 1 shows the structure of a three-dimensional image display device based on prior art;

FIG. 2 illustrates an operational principle of a typical three-dimensional display device;

FIG. 3 shows a structure to be applied to a vending machine according to one embodiment of the present invention;

FIG. 4 illustrates a terminal unit, in which a three-dimensional image display device according to one embodiment of the present invention is applied;

FIGS. 5 and 6 show the exterior of a terminal unit according to one embodiment of the present invention; and

FIG. 7 shows a flowchart for playing back a three-dimensional video in an unattended information terminal with a three-dimensional image display capability according to one embodiment of the present invention.

### DETAILED DESCRIPTION OF CERTAIN INVENTIVE EMBODIMENTS

Hereinafter, embodiments of this invention will be described in detail with reference to the accompanying drawings. In making reference to the accompanying drawings, identical or similar components regardless of the figure number will be given an identical reference numeral, and any redundant description will be omitted.

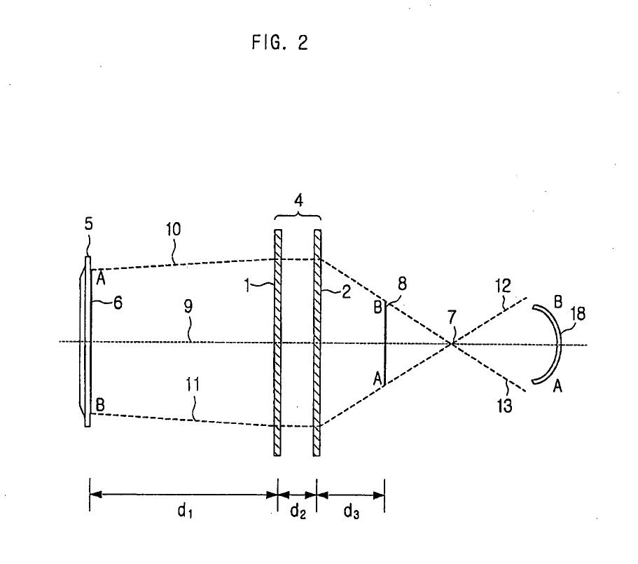

Referring to FIG. 2, which shows an operational principle for displaying a three-dimensional image according to one embodiment of the present invention, the principle of displaying a three-dimensional image by serially arranging two Fresnel lenses is as follows. Arranging 2 single Fresnel lenses serially shortens the focal length than that of a single Fresnel lens. The focal length can be manipulated by adjusting the gap between two Fresnel lenses. For example, serially arranging two Fresnel lenses having one focal length can shorten the focal length by half. By placing an image source in the back of these two Fresnel lenses according to the focal length, a three-dimensional image can be observed in the front of the Fresnel lenses. The focal plane for the three-dimensional image can be adjusted depending on the distance between the image source and the two Fresnel lenses.

Shown in FIG. 2 are a first Fresnel lens 1 and a second Fresnel lens 2, for creating a three-dimensional image in cooperation with an image source supply unit 5, and a film mask 3 for removing a reflection and a virtual image created by a double Fresnel lenses 4. Although the film mask 3 reduces transmissivity, a low-transmissive, colored film or one of the plastics with this film is used to keep a circular pattern, formed by the double Fresnel lenses, from showing. The film mask can be used for giving deeper perspective and background image, and it is also possible that a transmissive mask, with higher transmissivity, is used.

The optical principle for creating a three-dimensional image, with reference to FIG. 2, is as follows: A two-dimensional image 6 of the image source supply unit 5 is located about an optical axis 9 in the back of the first Fresnel lens 1, separated by a distance d1. The two-dimensional image of the image source supply unit 5 is projected along projection lines 10, 11 toward the first Fresnel lens 1, and the projected image is refracted toward the focal point of the first Fresnel lens 1 as it passes through the first Fresnel lens 1. The refracted image is refracted toward the focal point of the second Fresnel lens 2 as it passes through the second Fresnel lens 2. Consequently, the image is refracted toward a focal plane 8 inside a focal length 7 of the double Fresnel lenses 4. From the perspective of a viewer, the two-dimensional image A-B of the image source supply unit 5 is reversed to B-A on an actual three-dimensional focal plane 18, appearing as a three-dimensional image in the air.

The distance d1, between the image source supply unit 5 and the first Fresnel lens 1, and the distance d3, generated by the focal plane 8 within the focal length of the double Fresnel lenses, can be adjusted by controlling the distance d2 between the first Fresnel lens and the second Fresnel lens 2. Change in the distance d2 between the two lenses reduces the focal length of each Fresnel lens. The Fresnel lenses used here have either the same or different F numbers. The F numbers here are between 0.5 and 1.5, and can be varied within the structural scope of a preferred embodiment of the present invention.

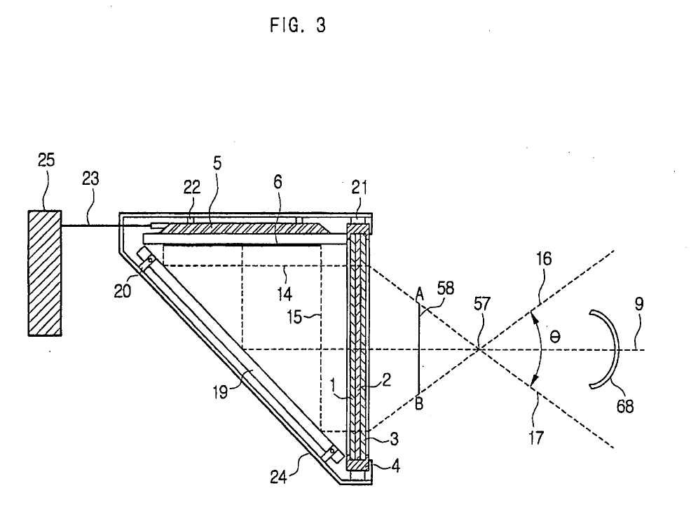

FIG. 3 shows the structure of a three-dimensional image display device according to one embodiment of the present invention.

In one embodiment, the three-dimensional image display device includes an image source supply unit for supplying an image source, a reflector, supported by a strut to form an acute angle with the image source supply unit, for reflecting the image source projected by the image source supply unit, a Fresnel lens unit, forming an acute angle with the reflector and supported by a strut to form a right angle with the image source supply unit, for forming a three-dimensional image on a focal plane by refracting and enlarging an image reflected by the reflector, and a control unit for organically controlling the image source supply unit, reflector, and Fresnel lens unit.

Referring to FIG. 3, in order to reduce the volume, the three-dimensional image display device comprises an image source supply unit 5, an image source strut 22 securing the image source supply unit, a reflector 19 and a reflector strut 20 for reducing the spatial optical projection distance of a two-dimensional image 6, a first Fresnel lens 1 and a second Fresnel lens 2 for forming a three-dimensional image, a film mask 3 for eliminating internal and external reflections created by a Fresnel lens and a circular pattern created by a lens, an external frame 4 securing the film mask, a lens strut 21 supporting the entire lens frame, a control unit 25 controlling an image of the image source supply unit 5, an image source connection cable 23, and a housing 24 for the three-dimensional image display device.

In one embodiment, an adequate distance is maintained between the image source supply unit and the double Fresnel lenses in order to have a three-dimensional image form on a focal plane 58 within the focal length 57. One embodiment of the present invention utilizes a minimal space by minimizing the optical path using a reflector 19 to provide a three-dimensional image. The optical principle is as follows: A two-dimensional image 6 of the image source supply unit 5 is refracted through the reflector 19 and is projected to the first Fresnel lens 1 along projection lines 14, 15. The image that passed through the first Fresnel lens 1 passes through the second Fresnel lens 2, and this projected image is refracted along projection lines 16, 17 toward the focal length 57 of the double Fresnel lenses and forms a three-dimensional image on the focal plane 8. The external focal plane. 68, which is the real focal plane for a three-dimensional image formed as described above, enables a wide visual angle θ when viewed from the perspective of a viewer. According to experiment results, a maximum horizontal and vertical range of viewing of about 60°˜about 90° about the optical axis 9 is possible.

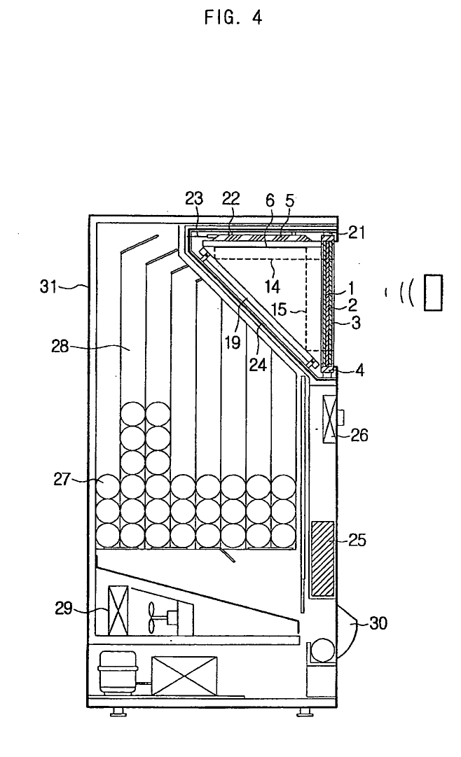

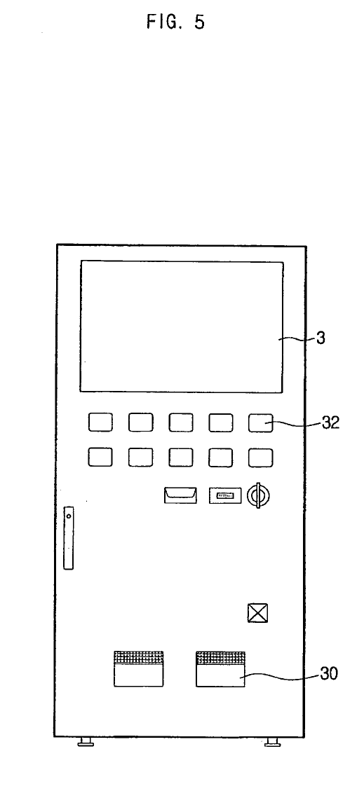

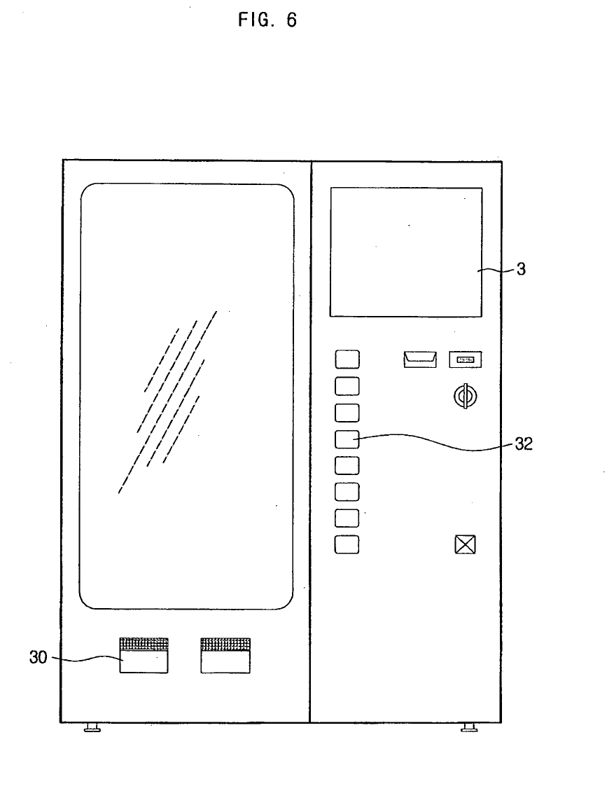

Illustrated in FIG. 4 is a terminal unit, in which a three-dimensional image display device according to one embodiment of the present invention is applied. FIGS. 5 and 6 show the exterior of a terminal unit according to one embodiment of the present invention.

Referring to FIG. 4, a three-dimensional image displaying vending machine 31 comprises a three-dimensional image display device unit 24 and a control unit 25, computerized to create an image of the image source supply unit. Inside the vending machine are a refrigerating control unit 29, storage paths 28 of cans 27, an outlet 30, an electronic control unit 26, and selection buttons 32. The three-dimensional image display device unit 24 may be integrated with the vending machine in the front, allowing an easy addition of cans 27 and maintenance.

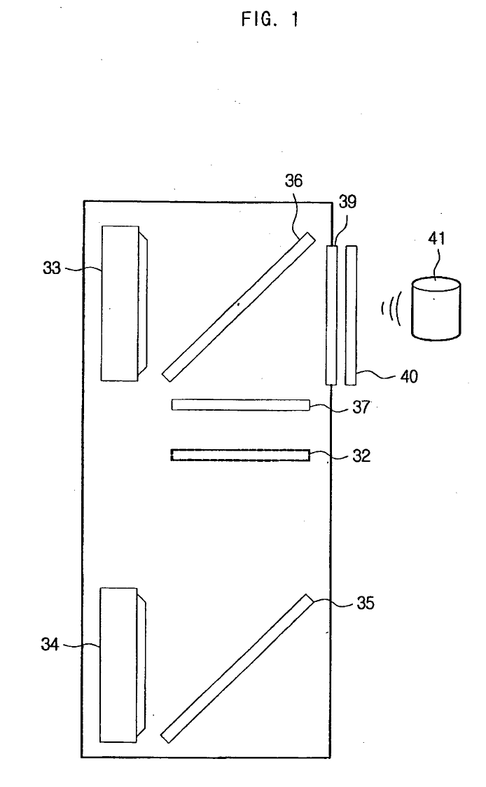

As in FIG. 4, one embodiment of the present invention is applied in a triangular structure inside a general can 27 vending machine such that a three-dimensional image is provided while maximizing the holding capacity of the cans. Commercial products, such as a vending machine, aims to generate profit by selling a large number of merchandise. Thus, in one embodiment of the present invention, a three-dimensional image can be provided using a minimal space while using the internal structure of a conventional vending machine. A structure such as the one shown in FIG. 4 can use a conventional vending machine with a moderate modification, thereby implementing one embodiment of the present invention without additional costs for fabricating or designing a new structure, while a conventional implementation, as in FIG. 1, necessitates large space.

In addition to an exterior, shown in FIG. 5, of a vending machine corresponding to FIG. 4, a large-size vending machine may arrange a separate space for the three-dimensional image display device. Even in a structure shown in FIG. 6, however, the space for the display device can be minimized, thereby allowing the installation of additional products or a control unit 25 for the three-dimensional image display device in the remaining space.

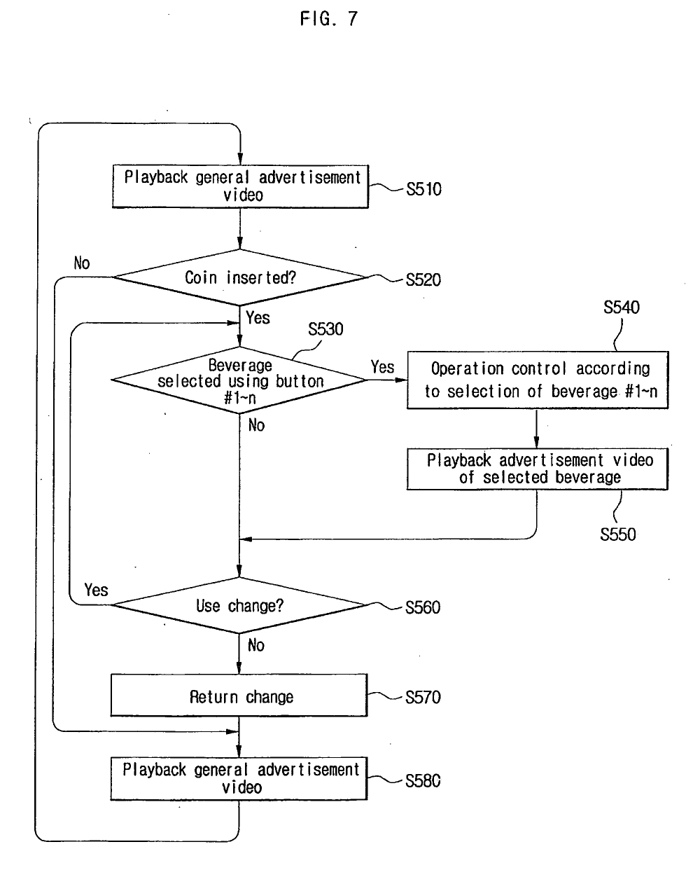

FIG. 7 is a flowchart for playing back a three-dimensional video in an unattended information terminal with a three-dimensional image display capability according to one embodiment of the present invention.

In one embodiment, the three-dimensional images for advertisement and playback can be structured in a variety of forms. One embodiment for commercial advertisement purposes is described below.

In step S510, general advertisement images are provided according to the cans 27 stored inside the three-dimensional image displaying vending machine 31, and the provided three-dimensional advertisement images are set to repeatedly play back if the vending machine is not used by a user.

If an appropriate amount of money is inserted into the three-dimensional image displaying vending machine 31 by a user in step S520, the control unit 25 recognizes the selection of the selection button 32 by the user in step S530. The control unit 25 controls a can of the beverage selected by the selection button to be discharged in step S540, and sets advertisement images of the particular beverage to be played back in step S550. If there is change from the purchase, step S560 checks if the change is to be used for another purchase. If the user requests the change, the change is given to the user in step S570.

With at least one embodiment of the present invention, general advertisement images can be returned and played back after the completion of advertisement images corresponding to the selected beverage. The control unit 25 can be integrated in the structure to play back and control relevant advertisement images. By connecting a speaker, sound can be played back with the images. By utilizing wireless technologies, relevant sound and images can be structured to be played back. These additional elements will provide better three-dimensional effects to the user.

A three-dimensional image display device according to one embodiment of the present invention, when industrially applied, can minimize the size expansion of a terminal unit by utilizing a minimal space of the major components in a conventional automated device.

Although certain preferred embodiments of the present invention have been described, other forms of implementations are possible through appropriate modifications. For example, implementations are possible in conventional forms of information terminals, such as variable kiosk types of unattended vending machines, unattended stand-alone advertisement systems, game machines, automated teller machines, unattended information systems, and unattended ticket counters. Moreover, conventional two-dimensional displays can be used together to provide much more effective three-dimensional images.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A three-dimensional image display device for a terminal, comprising:
an image supply unit configured to supply an image;
a reflector configured to reflect the image;
a Fresnel lens unit configured to receive the reflected image and form a three-dimensional image, wherein the image supply unit, the reflector and the Fresnel lens unit are adjacent to each other, and are configured in a triangular arrangement.

2. The device of claim 1, wherein the Fresnel lens unit, having a focal length, comprises a first Fresnel lens configured to refract the received image, and a second Fresnel lens configured to refract the refracted image towards a focal plane within the focal length.

3. The device of claim 1, further comprising a film mask configured to remove reflection and a virtual image created by the Fresnel lens unit.

4. The device of claim 1, wherein the triangular arrangement is essentially a right angle triangle.

5. The device of claim 4, further comprising a housing enclosing the image supply unit, the reflector and the Fresnel lens unit.

6. The device of claim 5, wherein the housing is essentially a right angle triangle, and wherein the image supply unit, the reflector and the Fresnel lens unit are attached to a respective inner surface of the housing.

7. The device of claim 6, wherein the image supply unit and the Fresnel lens unit are arranged to be substantially perpendicular to each other, and wherein the reflector is arranged to form an acute angle with respect to both of the image supply unit and the Fresnel lens unit.

8. The device of claim 1, further comprising a controller configured to control at least the image supply unit.

9. A three-dimensional image display device for a terminal, comprising:
an image supply unit configured to supply an image;
a reflector configured to reflect the image; and
a Fresnel lens unit configured to receive the reflected image and form a three-dimensional image, wherein the reflector and Fresnel lens unit are arranged such that the reflected image is directly incident on the Fresnel lens unit.

10. The device of claim 9, wherein the image supply unit, the reflector and the Fresnel lens unit are arranged together to form a generally right triangle.

11. The device of claim 10, wherein the image supply unit and the Fresnel lens unit are arranged to be substantially perpendicular to each other, and wherein the reflector is arranged to form an acute angle with respect to both of the image supply unit and the Fresnel lens unit.

12. A three-dimensional image display device for a terminal, comprising:
an image supply unit configured to supply an image;
a reflector configured to reflect the image;
a Fresnel lens unit configured to receive the reflected image and form a three-dimensional image, wherein the reflector and Fresnel lens unit are arranged such that the reflected image is directly incident on the Fresnel lens unit;
an input unit configured to select a three dimensional image; and
a controller configured to control the image supply unit to supply the image based on the selection of the input unit.

13. The device of claim 12, wherein the device is incorporated in a vending machine.

14. The device of claim 13, wherein the image supply unit, the reflector and the Fresnel lens unit are contained in a single housing.

15. The device of claim 14, wherein the housing is essentially a right angle triangle.

16. A method of providing a three-dimensional image for a terminal, comprising:
projecting an image in a first direction;
reflecting the projected image in a second direction; and
generating, at a Fresnel lens unit, a three-dimensional image based on the reflected image, wherein the reflected image is directly incident on the Fresnel lens unit.

17. The method of claim 16, wherein the first and second directions are substantially perpendicular to each other.

18. The method of claim 16, further comprising receiving a request for a three-dimensional image and the projecting of the image is responsive to the request.

19. A three-dimensional image display device for a terminal, comprising:
means for projecting an image in a first direction;
means for reflecting the projected image in a second direction substantially perpendicular to the first direction; and
means for generating, at a Fresnel lens unit, a three-dimensional image based on the reflected image, wherein the reflected image is directly incident on the Fresnel lens unit.
